(19) United States
(12) Patent Application Publication
(10) Pub. No.: US 2012/0266424 A1
(43) Pub. Date: Oct. 25, 2012

(54) Ornamental Urn

(75) Inventor: Michael C. Martino, Glen Rock, NJ (US)

(73) Assignee: URNAMENTS, LLC., Glen Rock, NJ (US)

(21) Appl. No.: 13/448,558

(22) Filed: Apr. 17, 2012

Related U.S. Application Data
(60) Provisional application No. 61/478,159, filed on Apr. 22, 2011.

(51) Int. Cl. A61G 17/08

(52) U.S. Cl. 27/1

(57) ABSTRACT

An ornamental keepsake urn for storing and displaying the remains of a loved one or pet during the holidays, such as from a Christmas tree or year round. The ornamental urn generally includes an upper member and a lower member. The upper member and lower member are generally removably connected to each other to form a unitary structure for storing cremated remains. The combined ornamental urn will generally have an egg-shaped appearance. The upper member will generally include a mounting assembly such as an eyelet or other structure for suspending the present invention from an object such as a tree. Both the upper and lower members will each have hollowed-out cavities within which the cremated remains will be stored. The upper and lower members will each have threaded portions which engage with each other to combine the two members to form the unitary egg-shaped ornament structure.

### CROSS REFERENCE TO RELATED APPLICATIONS

I hereby claim benefit under Title 35, United States Code, Section 119(e) of U.S. provisional patent application Ser. No. 61/478,159 filed Apr. 22, 2011. The 61/478,159 application is currently pending. The 61/478,159 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to an urn and more specifically it relates to an ornamental keepsake urn for storing and displaying the remains of a loved one or pet such as during the holidays or year round.

2. Description of the Related Art

Any discussion of the related art throughout the specification should in no way be considered as an admission that such related art is widely known or forms part of common general knowledge in the field.

In recent years, cremation has become a popular method of remembering loved ones who have passed away. It has been estimated that cremations will surpass burials in the United States by the year 2014. Containers for the storage of such cremated remains have been in use for years. Such urns are generally comprised of boxes or other containers which are adapted to be positioned on a mantle or other fixed location within a home. However, there is an absence of an urn container which is specifically geared toward the holidays and, more specifically, an ornamental urn which may be suspended from a tree or other object such as a Christmas tree or ornamental hanger.

As more people have become prone to accept cremation as a respectful alternative to burial, the same people are tending to appreciate more imaginative ways of remembering their loved ones. For example, instead of visiting the grave of a loved one during the holiday season, a family could instead hang the present invention from a Christmas tree or other object to commemorate their loved one.

Because of the inherent problems with the related art, there is a need for a new and improved ornamental urn for storing and displaying the remains of a loved one or pet during the holidays, such as from a Christmas tree or year round from an ornamental hanger.

### BRIEF SUMMARY OF THE INVENTION

The invention generally relates to an ornamental urn which includes an ornamental urn having an upper member and a lower member. The upper member and lower member are generally removably connected to each other to form a unitary structure for storing cremated remains. The combined ornamental urn will generally have an egg-shaped appearance. The upper member will generally include a mounting assembly comprised of an eyelet or other structure for suspending the present invention from an object such as a tree. Both the upper and lower members will each have hollowed-out cavities within which the cremated remains will be encapsulated. The upper and lower members will each have threaded portions which engage with each other to combine the two members to form the unitary egg-shaped ornament structure.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an side perspective view of the present invention being hung from an object.

FIG. 2 is an upper perspective view of the present invention.

FIG. 3 is an upper perspective view of the present invention, wherein the upper and lower members are separated.

FIG. 4 is a side sectional view of the present invention in use to store remains.

### DETAILED DESCRIPTION OF THE INVENTION

### A. Overview.

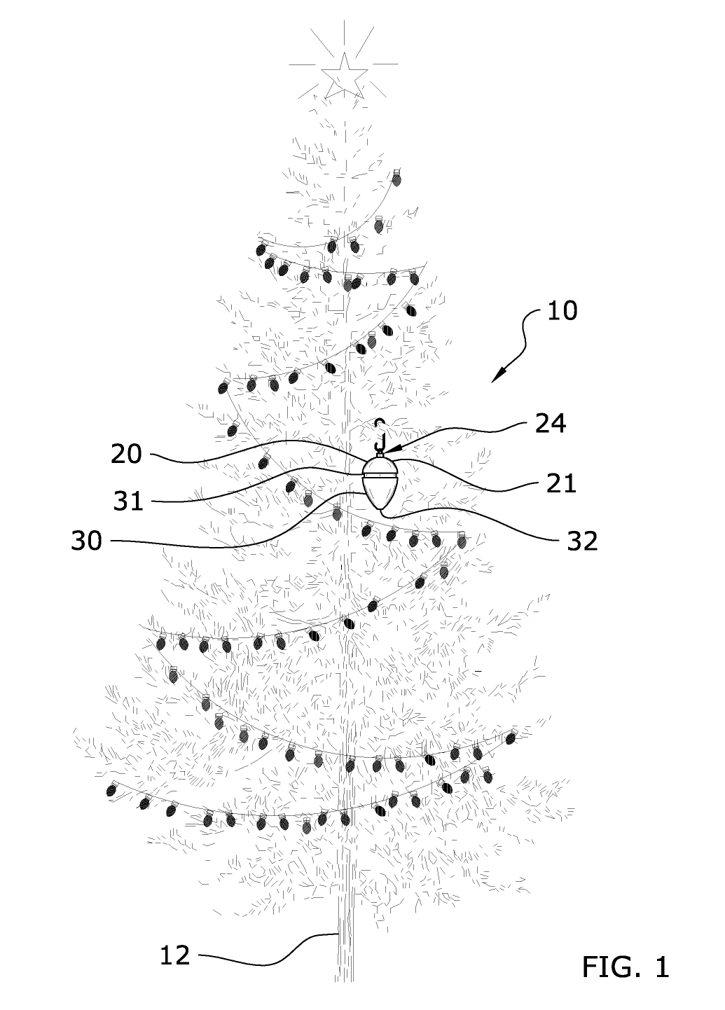

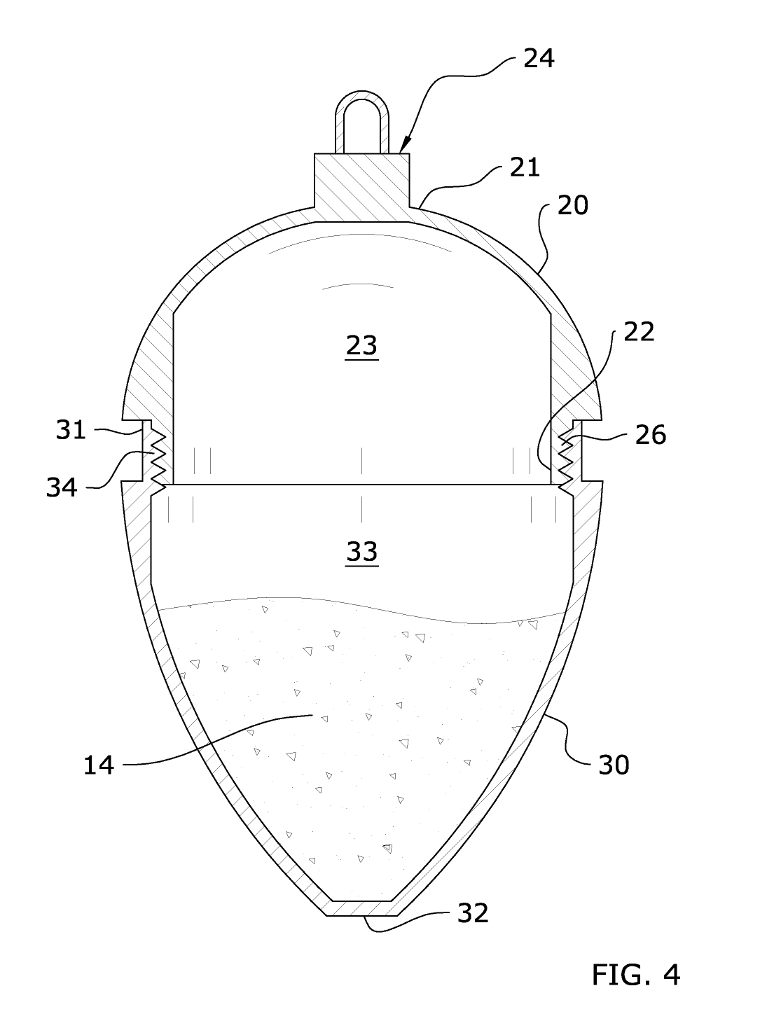

Turning now descriptively to the drawings, in which similar reference characters denote similar elements throughout the several views, FIGS. 1 through 4 illustrate an ornamental urn 10, which comprises an upper member 20 and a lower member 30. The upper member 20 and lower member 30 are generally removably connected to each other to form a unitary structure for storing cremated remains 14. The combined ornamental urn 10 will generally have an egg-shaped appearance. The upper member 20 will generally include a mounting assembly 24 such as an eyelet, hook and/or other structure for suspending the present invention from an object such as a tree 12. Both the upper and lower members 20, 30 will each have hollowed-out cavities 23, 33 within which the cremated remains 14 will be stored. The upper and lower members 20, 30 will each have threaded portions 26, 34 which engage with each other to combine the two members 20, 30 to form the unitary egg-shaped ornament structure 10.

As shown in FIG. 1, the ornamental urn 10 will generally be comprised of an egg-shaped container which includes a mounting assembly 24 for removably securing the ornamental urn 10 to an object such as a tree 12. However, it should be appreciated by one of ordinary skill in the art that various other shapes may be utilized for the ornamental urn 10, and the present invention should not be construed as being limited to the shape and/or size shown in the figures. By way of example and without limitation, the ornamental urn 10 could be comprised of a sphere, triangular, polygon, rectangular or other shape without affecting its overall operation.

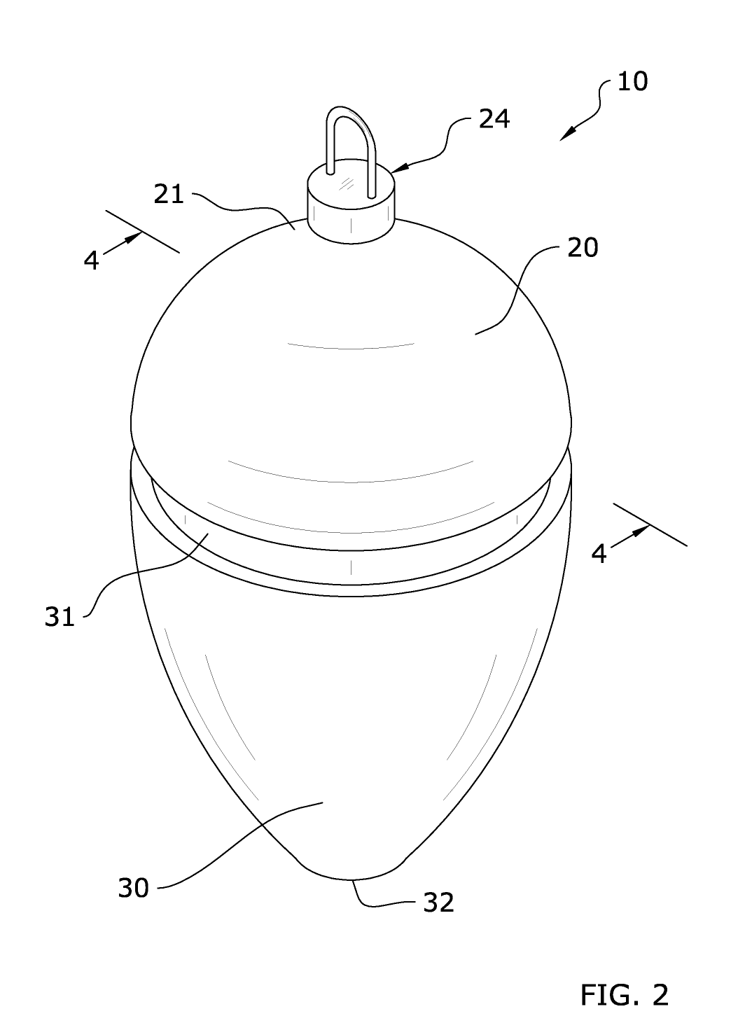

As shown in FIG. 2, the ornamental urn 10 of the present invention will generally be comprised of an upper member 20 and a lower member 30. The upper and lower members 20, 30 may be removably attached to each other to form the unitary structure of the ornamental urn 10. It is appreciated that, in some embodiments, the upper and lower members 20, 30 may be integrally formed and, instead, a door or other access point may be utilized to store any remains 14 in the cavities 23, 33 within.

### B. Upper Member.

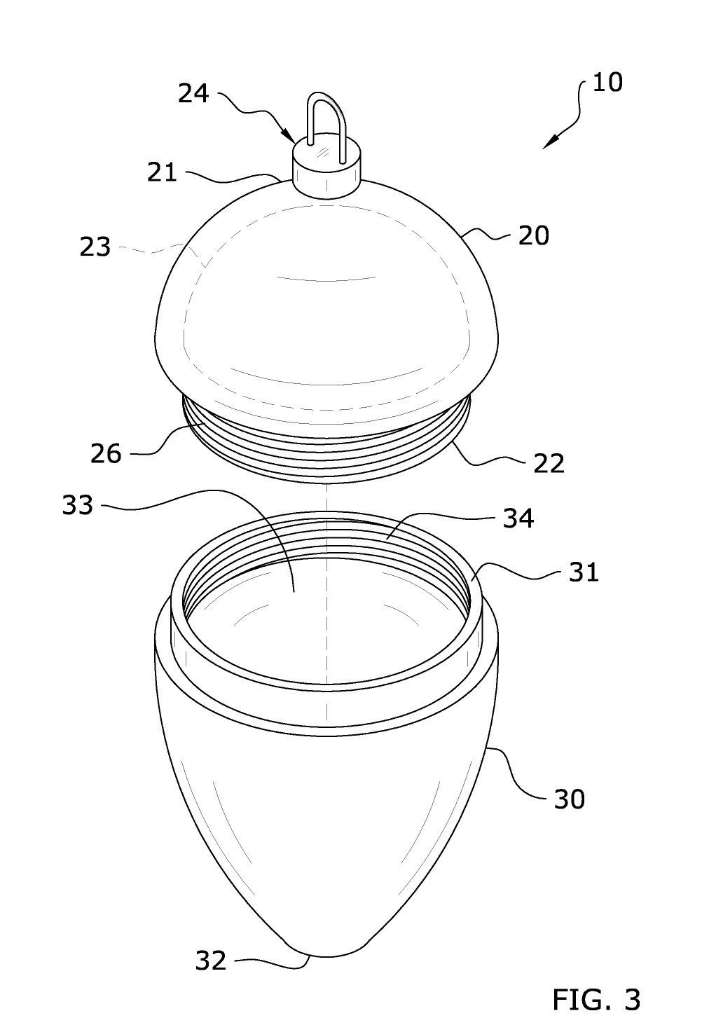

As shown in FIG. 1, the present invention will generally include an upper member 20 having an upper end 21 and a lower end 22. The upper member 20 of the ornamental urn 10 of the present invention will generally be comprised of a semi-elliptical shape as shown in FIG. 3. However, it is appreciated that various other shapes me be utilized. Further, the size of the upper member 20 of the ornamental urn 10 may vary for different applications. The upper member 20 may be comprised of a simple design or may have ornamental figures, etchings or the like on its outer surface to further improve the aesthetic appearance of the present invention or to commemorate a specific occasion.

The upper member 20 of the ornamental urn 10 of the present invention will generally be hollow so as to include a cavity 23 for storage of cremated remains 12 or other items. The cavity 23 will generally be accessible through the opening at the lower end 22 of the upper member 20.

The upper member 20 will also generally include a mounting assembly 24 comprised of an eyelet, hook and/or other structure positioned at its upper end 21 which will be utilized to suspend or hang the ornamental urn 10 from a tree 12 or other object. The upper member 20 will also generally include a threaded portion 26 for engaging with the corresponding threaded portion 34 on the lower member 30 to combine the two members 20, 30 and form a unitary ornamental urn 10.

### C. Lower Member.

As shown in FIG. 1, the present invention will generally include a lower member 30 having an upper end 31 and a lower end 32. The lower member 30 of the ornamental urn 10 of the present invention will generally be comprised of a semi-elliptical shape as shown in FIG. 3. However, it is appreciated that various other shapes me be utilized. It is preferable that the lower member 30 and upper member 20 of the ornamental urn 10 utilize similar shapes to create a unitary and uniform shape when combined. Further, the size of the lower member 30 of the ornamental urn 10 may vary for different applications. The lower member 30 may be comprised of a simple design or may have ornamental figures, etchings or the like on its outer surface to further improve the aesthetic appearance of the present invention or to commemorate a specific occasion.

The lower member 30 of the ornamental urn 10 of the present invention will generally be hollow so as to include a cavity 33 for storage of cremated remains 12 or other items. The cavity 33 will generally be accessible through the opening at the lower end 32 of the lower member 30.

The lower member 30 will also generally include a threaded portion 34 positioned at its upper end 31 for engaging with the corresponding threaded portion 26 on the lower member 20 to combine the two members 20, 30 and form a unitary ornamental urn 10 with a single internal cavity for storage of remains 12.

### D. Operation of Preferred Embodiment.

In use, the upper member 20 and lower member 30 may be separated from each other by twisting the upper member 20 and thus disengaging the threaded portions 26, 34. When so separated, the remains 12 may be placed within the cavity 32 of the lower member 30. The upper member 20 may then be reconnected to the lower member 30 by twisting them back together and engaging the threaded portions 26, 34. The ornamental urn 10 may then be hung from a tree or other item by utilizing the mounting assembly 24.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. In case of conflict, the present specification, including definitions, will control. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. An ornamental urn for storing and displaying cremated remains, comprising:
an upper member, wherein said upper member includes an upper end and a lower end; and
a lower member, wherein said lower member is removably attached to said upper member, wherein said lower member includes a cavity for storage of cremated remains.

2. The ornamental urn for storing and displaying cremated remains of claim 1, wherein said lower member includes an upper end and a lower end, wherein said lower end of said upper member is removably attached to said upper end of said lower member.

3. The ornamental urn for storing and displaying cremated remains of claim 1, wherein said upper member includes a cavity.

4. The ornamental urn for storing and displaying cremated remains of claim 1, wherein said upper end of said upper member includes a mounting assembly.

5. The ornamental urn for storing and displaying cremated remains of claim 4, wherein said mounting assembly is comprised of an eyelet.

6. The ornamental urn for storing and displaying cremated remains of claim 1, wherein said lower end of said upper member includes a threaded portion.

7. The ornamental urn for storing and displaying cremated remains of claim 6, wherein said upper end of said lower member includes a threaded portion.

8. The ornamental urn for storing and displaying cremated remains of claim 8, wherein said threaded portion of said upper end of said lower member is adapted to removably secure with said threaded portion of said lower end of said upper member.

9. The ornamental urn for storing and displaying cremated remains of claim 1, wherein said upper member is comprised of a semi-elliptical shape.

10. The ornamental urn for storing and displaying cremated remains of claim 9, wherein said upper member and said lower member are symmetrically shaped.

11. An ornamental urn system for storing and displaying cremated remains, comprising:
an upper member, wherein said upper member includes an upper end and a lower end;
a lower member, wherein said lower member is removably attached to said upper member, wherein said lower member includes a cavity;
cremated remains, wherein said cremated remains are positioned within said cavity of said lower member; and
an object, wherein said upper member is adapted to be removably hung from said object.

12. The ornamental urn for storing and displaying cremated remains of claim 11, wherein said lower member includes an upper end and a lower end, wherein said lower end of said upper member is removably attached to said upper end of said lower member.

13. The ornamental urn for storing and displaying cremated remains of claim 11, wherein said object is comprised of a tree.

14. The ornamental urn for storing and displaying cremated remains of claim 1, wherein said upper end of said upper member includes a mounting assembly.

15. The ornamental urn for storing and displaying cremated remains of claim 4, wherein said mounting assembly is comprised of an eyelet.

16. The ornamental urn for storing and displaying cremated remains of claim 1, wherein said lower end of said upper member includes a threaded portion.

17. The ornamental urn for storing and displaying cremated remains of claim 6, wherein said upper end of said lower member includes a threaded portion.

18. The ornamental urn for storing and displaying cremated remains of claim 8, wherein said threaded portion of said upper end of said lower member is adapted to removably secure with said threaded portion of said lower end of said upper member.

19. A method of storing and displaying cremated remains, comprising:
providing an ornamental urn, wherein said ornamental urn is comprised of an upper member and a lower member, wherein said upper member includes a mounting assembly;
placing cremated remains within a cavity formed within said lower member;
removably securing said upper member to said lower member so as to enclose said cavity; and
hanging said ornamental urn from an object using said mounting assembly.

20. The method of storing and displaying cremated remains of claim 19, wherein said object is comprised of a tree.
